(19) United States
(12) Patent Application Publication
(10) Pub. No.: US 2024/0289400 A1
(43) Pub. Date: Aug. 29, 2024

(54) FREQUENT PATTERN MINING METHOD BASED ON SPATIAL INDEX

(71) Applicant: Hangzhou Dianzi University, Hangzhou City (CN)

(72) Inventors: Changben Zhou, Hangzhou City (CN); Jian Xu, Hangzhou City (CN)

(21) Appl. No.: 18/517,355

(22) Filed: Nov. 22, 2023

(30) Foreign Application Priority Data
Feb. 28, 2023 (CN) 202310175453.7

(51) Int. Cl. G06F 16/9537; G06F 16/9536; G06Q 50/00

(52) U.S. Cl. CPC G06F 16/9537; G06F 16/9536; G06Q 50/01

(57) ABSTRACT

The present disclosure relates to the technical field of computer application. In an embodiment, a frequent pattern mining method based on a spatial index includes preprocessing data of a geographic social network, constructing a tree-like spatial index NaR-Tree, mining frequent patterns, setting a target search area, a result set size k and an example pattern c, and returning k patterns with the highest frequency expanded from c in the target area, and returning a result set comprising k patterns.

### CROSS REFERENCE TO RELATED APPLICATION

This patent application claims the benefit and priority of Chinese Patent Application No. 2023101754537, filed with the China National Intellectual Property Administration on Feb. 28, 2023, the disclosure of which is incorporated by reference herein in its entirety as part of the present application.

### TECHNICAL FIELD

The present disclosure relates to the technical field of computer application and, in particular embodiments, to a frequent pattern mining method based on a spatial index.

### BACKGROUND

In recent years, with the popularity of smart mobile devices and the Internet, a huge amount of user data has also been generated. In order to make these application services more intelligent, it is crucial to mine behavior patterns and basic relationships between users. Frequent pattern mining is an important branch in the field of data mining, and is the basis of other pattern mining. However, due to tens of thousands of candidate patterns generated during mining, it is very difficult to mine efficiently. In addition, conventional frequent pattern mining methods often regard social networks as a whole, and fail to make use of users' geographic location information, so that it is impossible to mine networks in fine granularity.

### SUMMARY

Embodiments of the present disclosure provide a frequent pattern mining method based on a spatial index, to solve the above technical problems.

To solve the above technical problems, specific technical solutions of a frequent pattern mining method based on a spatial index according to the present disclosure is as follows.

A frequent pattern mining method based on a spatial index includes the following steps:
step 1: preprocessing data of a geographic social network: integrating geographic location information in the geographic social network, and assigning a location label to each node as a basis for building a tree-like spatial index and mining frequent patterns in subsequent steps; where the node represents an entity in a social network and has location and type attributes;
step 2: constructing a tree-like spatial index NaR-Tree: constructing an NaR-Tree index structure according to geographic location attributes of nodes and a coverage relationship between areas, where the spatial index transforms an area retrieval problem into a tree search problem, that is, nodes representing a target area are searched for from a root node;
step 3: mining frequent patterns: setting a target search area, a result set size k and an example pattern c, and returning k patterns with the highest frequency expanded from c in the target area; and
step 4: returning a result set including k patterns.

Further, step 2 includes the following specific steps: specifying that each node of a geographic social network graph G (V, E, L) contains geographic location information of a current node; and constructing a data file by r rectangles, where each node of NaR-Tree accommodates n rectangles, and a specific construction process comprises the following:
step 2.1: preprocessing the data file;
step 2.2: constructing leaf nodes;
step 2.3: merging nodes at the same layer; and
step 2.4: generating the root node.

Further, step 2.1 includes the following specific steps: preprocessing the data file, so that r nodes in the file are in [r/n] continuous rectangular groups respectively, and arranging these rectangular groups in order according to geographic locations, where all nodes included in the network graph, and all edge types and a number of edge types are recorded in the rectangles for edge filtering during subgraph retrieval.

Further, step 2.2 includes the following specific steps: converting each rectangle group generated in step 2.1 into a leaf node, where each leaf node includes at most n rectangles.

Further, step 2.3 includes the following specific steps: merging tree nodes with a small distance at the same layer, with a minimum bounding rectangle corresponding to the tree nodes as one of rectangles in tree nodes at an upper layer, where graph information contained in the nodes is merged while the tree nodes are merged, and the minimum bounding rectangle refers to a minimum rectangle that can cover the current tree node.

Further, step 2.4 includes the following specific steps: iterating operations of step 2.3 from the layer where the leaf nodes are located until the root node is generated, that is, until all rectangles are covered.

Further, step 3 includes the following specific steps:
step 3.1: accessing NaR-Tree to determine a node where a target search area is located, where a process of searching for the node where the target area is located from NaR-Tree is a process similar to tree search, including:
   step 3.1.1: checking whether the current node covers the target search area; and
   step 3.1.2: if yes, accessing child nodes of the current node and performing step 3.1.1; or
   if not, returning to the current node; and
   performing operations of steps 3.1.1 and 3.1.2 from the root node until a return result, that is, the minimum bounding rectangle containing the target search area, is obtained;
step 3.2: retrieving a subgraph: retrieving and generating, in G, a subgraph corresponding to the target area according to subgraph information stored in the tree node after the NaR-Tree node corresponding to the target search area is obtained, including the following specific steps:
   step 3.2.1: obtaining all graph nodes (v1, v2, . . . , vn) stored in the NaR-Tree node; and
   step 3.2.2: retrieving edges that are interconnected and meet user type requirements, between the above nodes from G; and
   constructing a corresponding subgraph S according to node and edge information obtained in steps 3.2.1 and 3.2.2;
step 3.3: initializing priority queues: initializing two priority queues required for a mining pattern, including the following specific steps:
   step 3.3.1: generating a maximum priority queue q1 and a minimum priority queue q2, where a ranking standard of the priority queues is a support degree of the pattern in the queue, and a size of q2 is set to k; the maximum priority queue q1 serves as a candidate set, and the minimum priority queue q2 serves as a result set; and the support degree of the pattern refers to a minimum mapped value of edges in the pattern in all examples, and is a frequency indicator; and
   step 3.3.2: calculating a support degree of an initial pattern c, and placing c into q1;
step 3.4: dequeuing a head element p1 of q1, and comparing with a head element p2 of q2 in support degree;
step 3.5: performing the following steps if the support degree of p1 is greater than that of p2:
   step 3.5.1: performing an inert retrieval operation according to node and edge information of p1 to accelerate support degree calculation; and
   step 3.5.2: calculating a true support degree of p1; if the true support degree is still greater than that of p2, dequeuing p2 and expanding p1, and finally enqueuing p1; and
repeating steps 3.4 and 3.5 until the queue q1 is null, where at this time, k elements in q2 are required k frequent patterns.

Further, step 3.3.2 includes the following specific steps: calculating the support degree of the pattern c according to edge information of an example of c in the subgraph S, including the following specific steps:
a1: obtaining all examples {I1, I2, . . . , Im} of c in the subgraph S;
a2: obtaining all edge information of all the examples to generate an edge set; and
a3: counting and returning a number of unique edges in the edge set, where a value returned by step a3 is the support degree of the pattern c and the mining operation officially starts after the initialization step is completed.

Further, the inert retrieval operation step of step 3.5.1 includes the following steps:
b1: skipping performing re-retrieval if node and edge types of p1 are included in S; and
b2: otherwise, retrieving S again.

Further, the step of expanding p1 of step 3.5.2 includes the following steps:
c1: generating all possible sub-patterns of p1 according to stored edge information in the NaR-Tree node;
c2: temporarily setting the support degree of the sub-patterns as a real support degree of p1; and
c3: adding all the generated sub-patterns to q1.

The frequent pattern mining method based on a spatial index according to the present disclosure has the following advantages: According to the present disclosure, by constructing the spatial index of the geographic social network, geographic location information of the network and structural information within an area are stored by using a tree-like index structure. After the index structure is constructed, a target search area can be located efficiently, and subgraph information that meets edge type requirements can be obtained, to reduce the subgraph region to improve mining efficiency.

According to the present disclosure, by means of the spatial index structure, the scope of frequent pattern mining operation is detailed from a complete graph to an area in the graph, which can help to analyze differences of user's behavior patterns, social preferences and other characteristics between areas by comparing frequent patterns in different areas.

### BRIEF DESCRIPTION OF THE DRAWINGS

FIG. 1A is a schematic diagram of an initial pattern P;

FIG. 1B is a schematic diagram of a graph G including 12 vertices;

FIG. 2 is a schematic diagram of division of a minimum bounding rectangle of the graph G;

FIG. 3 is a schematic diagram of a tree-like spatial index structure of the graph G; and

FIG. 4 is a schematic diagram of an example of index structure search.

### DETAILED DESCRIPTION OF THE EMBODIMENTS

In order to better understand the objectives, structure and functions of the present disclosure, a frequent pattern mining method based on a spatial index according to the present disclosure will be described in detail below with reference to the accompanying drawings.

According to the present disclosure, a geographic social network G (V, E, L) is given, where V refers to a set of all user nodes in the network, E refers to a connection between users, and L refers to a label restriction of nodes in the graph. Every node in V contains a geographic location attribute, that is, a latitude and a longitude of a user's location. G (V, E, L) includes a plurality of frequent patterns that need to be mined.

The pattern referred to in the present disclosure refers to a weakly connected subgraph obtained from a pattern space, where each node includes a label, and all edges in the pattern exist in the graph G.

An example referred to in the present disclosure refers to an isomorphic subgraph corresponding to the pattern in the graph G.

The frequent pattern mining involved in the present disclosure refers to inputting an example pattern and an integer k, and mining k patterns with the highest support degree in the graph G.

In the present disclosure, the support degree index is evaluated by using a method based on a minimum edge mapping support degree, that is, a number of different edges in all examples corresponding to the patterns.

During mining of the frequent patterns, division of a search area needs traversal of all nodes in the graph and comparison of geographic location information of the nodes. This process has a too high time cost in a large network, so there is a very urgent requirement for an efficient spatial index to accelerate area retrieval. In order to ensure accuracy of search results, it is also needed to generate all potential frequent patterns and compare support degrees of these patterns. How to reduce a number of candidate patterns is also the focus of the present disclosure.

The innovation of the present disclosure includes using the geographic location information of users during frequent pattern mining, so that the mining operation can be detailed to a specific area in the network, such as a city, a community, and a school. A suitable spatial index is designed to accelerate the area retrieval process. In addition, the pattern expansion process is optimized according to the information stored in the spatial index, so as to reduce the number of candidate patterns.

Specifically, a frequent pattern mining method based on a spatial index according to the present disclosure includes the following steps.

Step 1: Preprocess data of a geographic social network:

Integrate geographic location information in the geographic social network, and assign a location label to each node as a basis for building a tree-like spatial index and mining frequent patterns in subsequent steps.

Step 2: Construct a tree-like spatial index NaR-Tree:

Construct an NaR-Tree index structure according to geographic location attributes of nodes and a coverage relationship between areas. This spatial index transforms an area retrieval problem into a tree search problem, that is, nodes representing a target area are searched for from a root node.

Each node of a geographic social network graph G (V, E, L) contains geographic location information of a current node. A process of constructing NaR-Tree includes: preprocessing a data file, constructing leaf nodes, merging nodes at the same layer, and generating the root node.

It is assumed that the data file includes r rectangles, and each node of NaR-Tree may accommodate n rectangles.

A specific construction process includes the following steps.

Step 2.1: Preprocess the data file:

Preprocess the data file, so that r nodes in the file are in [r/n] continuous rectangular groups respectively, and arrange these rectangular groups in order. All nodes included in the network graph, and all edge types and a number of edge types are recorded in the rectangles.

Step 2.2: Construct leaf nodes:

Convert each rectangle group generated in the previous step into a leaf node, where each leaf node includes at most n rectangles.

Step 2.3: Merge nodes at the same layer:

Merge tree nodes with a small distance at the same layer, with a minimum bounding rectangle corresponding to the tree nodes as one of rectangles in tree nodes at an upper layer. Graph information contained in the nodes is merged while the tree nodes are merged.

Step 2.4: Generate the root node:

Iterate operations of the previous step from the layer where the leaf nodes are located until the root node is generated, that is, until all rectangles are covered.

Step 3: Mine frequent patterns:

Set a target search area, a result set size k and an example pattern c. Return k patterns with the highest frequency expanded from c in the target area.

The specific steps of frequent pattern mining are as follows.

Step 3.1: Access NaR-Tree to determine a node where a target search area is located.

A process of searching for the node where the target area is located from NaR-Tree is a process similar to tree search, including the following steps.

Step 3.1.1: Check whether the current node covers the target search area.

Step 3.1.2: If yes, access child nodes of the current node and performing step 3.1.1; or
if not, return to the current node; and
perform operations of steps 3.1.1 and 3.1.2 from the root node until a return result, that is, the minimum bounding rectangle containing the target search area, is obtained.

Step 3.2: Retrieve a subgraph:

Retrieve and generate, in G, a subgraph corresponding to the target area according to subgraph information stored in the tree node after the NaR-Tree node corresponding to the target search area is obtained. Specific steps are as follows.

Step 3.2.1: Obtain all graph nodes (v1, v2, . . . , vn) stored in the NaR-Tree node.

Step 3.2.2: Retrieve interconnected edges between the above nodes from G; and
construct a corresponding subgraph S according to node and edge information obtained in steps 3.2.1 and 3.2.2.

Step 3.3: Initialize priority queues:

Initialize two priority queues required for a mining pattern, including the following specific steps.

Step 3.3.1: Generate a maximum priority queue q1 and a minimum priority queue q2, where a ranking standard of the priority queues is a support degree of the pattern in the queue, and a size of q2 is set to k.

Step 3.3.2: Calculate a support degree of an initial pattern c, and place c into q1:

Calculate the support degree of the pattern c according to edge information of an example of c in the subgraph S, including the following specific steps.
a1: Obtain all examples {I1, I2, . . . , Im} of c in the subgraph S.
a2: Obtain all edge information of all the examples to generate an edge set.
a3: Count and return a number of unique edges in the edge set, where a value returned by step a3 is the support degree of the pattern c.

The mining operation can officially start after the initialization step is completed.

Step 3.4: Dequeue a head element p1 of q1, and compare with a head element p2 of q2 in support degree.

Step 3.5: Perform the following steps if the support degree of p1 is greater than that of p2.

Step 3.5.1: Perform an inert retrieval operation according to node and edge information of p1 to accelerate support degree calculation.

The inert retrieval operation step includes the following steps.

b1: Skip performing re-retrieval if node and edge types of p1 are included in S.

b2: Otherwise, retrieve S again.

Step 3.5.2: Calculate a true support degree of p1; and if the true support degree is still greater than that of p2, dequeue p2 and expand p1, and finally enqueue p1.

The step of expanding p1 includes the following steps.

c1: Generate all possible sub-patterns of p1 according to stored edge information in the NaR-Tree node.

c2: Temporarily set the support degree of the sub-patterns as a real support degree of p1.

c3: Add all the generated sub-patterns to q1.

Repeat steps 3.4 and 3.5 until the queue q1 is null. At this time, k elements in q2 are required k frequent patterns.

Step 4: Return a result set including k patterns.

### Embodiment

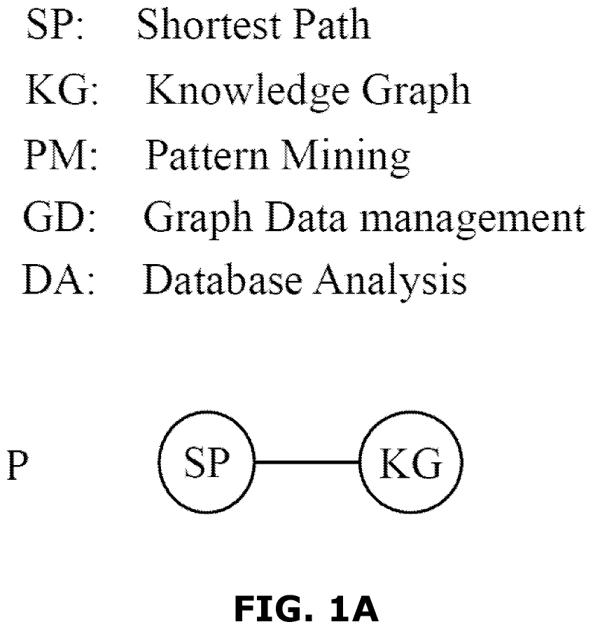

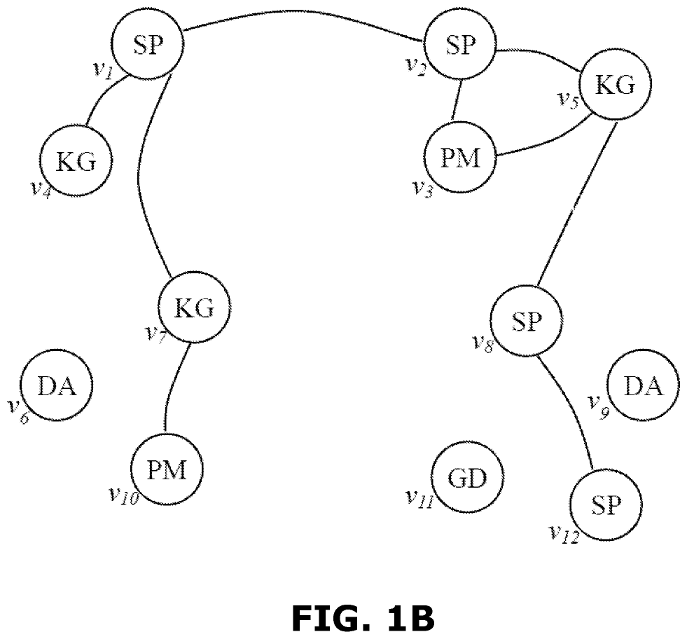

FIG. 1A is an initial pattern P, and FIG. 1B is a graph G including 12 vertices. An embodiment of the present disclosure will be described below by taking this graph as an example.

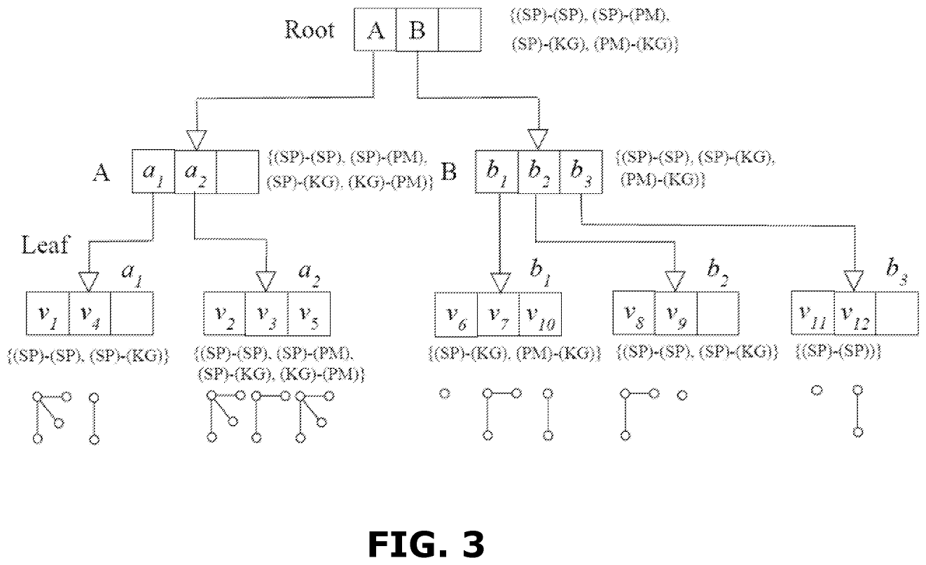

A tree-like spatial index structure of the graph G is shown in FIG. 3. A spatial index is constructed by performing step 2 of the present disclosure. The following operations are performed.

A minimum bounding rectangle is provided for each of ten nodes in the graph G by division, and the 12 nodes are recorded as a minimum operable area of the index.

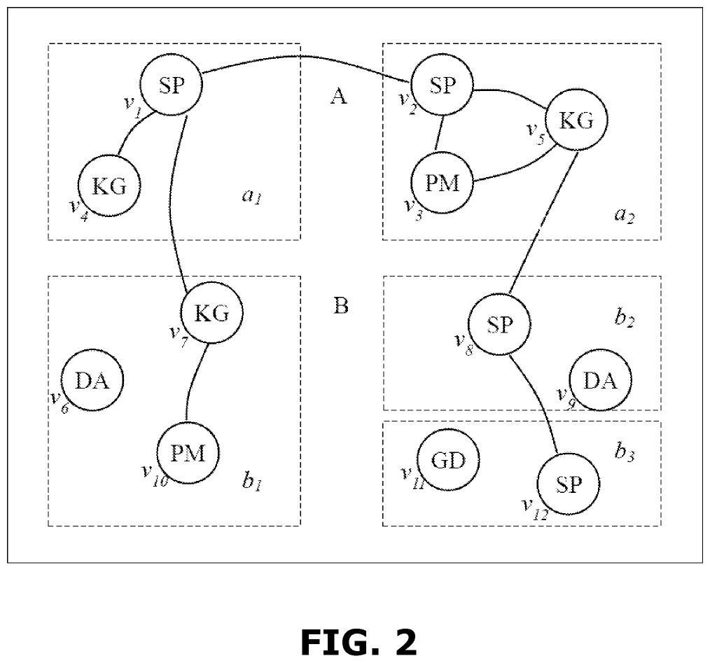

FIG. 2 shows obtaining of the minimum bounding rectangles by division, which is implemented by performing step 2-1 of the present disclosure.

Rectangles with a small distance fall into the same group, and the 12 nodes in the graph G fall into five groups: a1, a2, b1, b2, and b3. Specifically, the five groups are (v1, v4), (v2, v3, v5), (v6, v7, v10), (v8, v9), and (v11, v12).

With the generated five groups as five leaf nodes of the tree-like spatial index, a minimum bounding rectangle is provided for each leaf node by division.

Areas represented by five leaf nodes are merged, and minimum bounding rectangles are provided for two generated nodes by division. Specifically, a1 and a2 are merged as A; and b1, b2 and b3 are merged as B;

The two generated nodes A and B are taken as nodes of a second layer of the tree-like spatial index.

Areas represented by the two nodes A and B are merged and a minimum bounding rectangle that can cover the whole graph is generated.

The generated final node is taken as the root node of the tree-like spatial index.

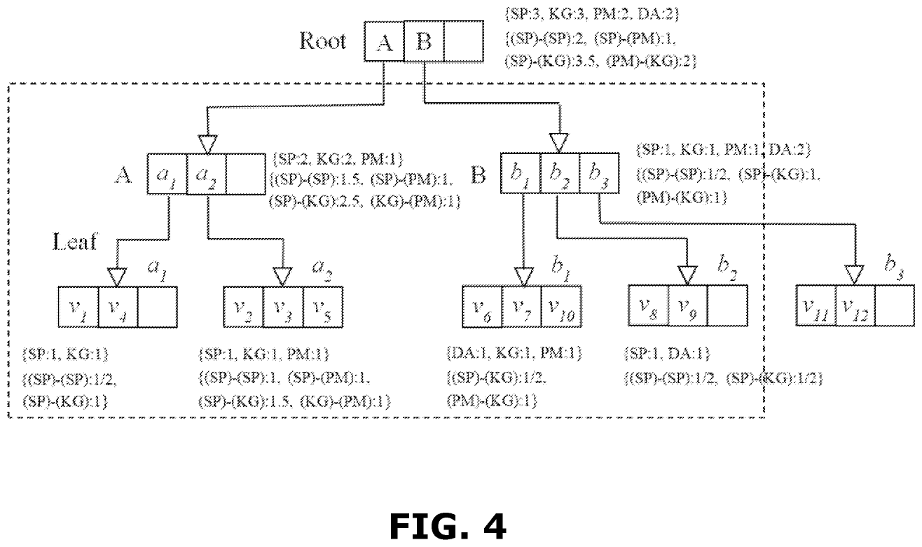

FIG. 4 shows search results in the tree-like spatial index after area division, which are obtained by performing steps 3-1-1 and 3-1-2 of the present disclosure.

For example, a1, a2, b1 and b2 are taken as target search areas, and the following operations are performed on the tree-like spatial index:

From the root node Root, which covers the target search area, two child nodes of the root node are searched for.

An area covered by the node A is a part of the target search area, and then its leaf nodes are searched for.

The node A is updated with graph node information and edge information contained in the leaf nodes a1 and a2.

The node B is not completely covered by the target search area, where b1 and b2 belong to the target search area while b3 does not belong to the target search area, so no search is performed.

The leaf nodes b1 and b2 are searched for, and information stored in the node B is updated.

The information stored in the root node is updated with the nodes A and B, and at this time, the tree-like spatial index has been searched and updated.

A pattern P (SP-KG) in FIGS. 1A-B is an initial pattern of frequent pattern mining, and k is a desired result set size, and is set to 3. Frequent pattern mining needs the performing of steps 3-3 to 3-5 of the present disclosure and the following operations are performed:

A maximum priority queue q1 and a minimum priority queue Q2 with a scale of 3 are initialized.

The support degree of P is calculated, and according to a number of unique edges, it can be seen that the support degree of (SP-KG) is 4.

P is added to the queue q1.

A head element (SP-KG) of q1 is dequeued.

At this time, q2 is null, p1 is expanded, and potential candidate patterns are (SP-KG-PM), (SP-SP-KG), (KG-SP-KG), (PM-SP-KG), and (SP-KG-PM-SP). 4 is taken as the initial support degree of candidate patterns.

The above five candidate nodes are added into the queue q1.

A head element (SP-KG-PM) of q1 is dequeued.

The support degree of (SP-KG-PM) is calculated, and the result is 2. At this time, the queue q2 is not full.

The pattern (SP-KG-PM) is expanded to generate a series of candidate patterns, and the initial support degree is set to 2 and is added to the queue q1.

(SP-KG-PM) is added into the queue q2, and at this time, the queue q2 is not full.

A head element (SP-SP-KG) of q1 is dequeued.

The support degree of (SP-SP-KG) is calculated, and the result is 1. At this time, the queue q2 is not full.

The pattern (SP-SP-KG) is expanded to generate a series of candidate patterns, and the initial support degree is set to 1 and is added to the queue q1,

(SP-SP-KG) is added into the queue q2, and at this time, the queue q2 is full.

The remaining candidate patterns in q1 are dequeued one by one, and the support degree is calculated.

(KG-SP-KG), (PM-SP-KG) and (SP-KG-PM-SP) and other candidate patterns each have a support degree of 1, which is less than or equal to the support degree of the head element of q2, and thus cannot be added to q2 and there is no need to perform an expansion operation.

When q1 is null, the pattern in q2 is a result set {SP-KG, SP-KG-PM, (SP-SP-KG)}.

The result is returned.

It can be understood that the present disclosure is described by means of some embodiments, and those skilled in the art should know that various changes or equivalent substitutions can be made to the features and embodiment without departing from the spirit and scope of the present disclosure. In addition, under the teaching of the present disclosure, these features and embodiments can be modified to adapt to specific conditions and materials without departing from the spirit and scope of the present disclosure. Therefore, the present disclosure is not limited by the specific embodiments disclosed herein, and all embodiments falling within the scope of the claims of the present application should fall within the protection scope of the present disclosure.

What is claimed is:

1. A frequent pattern mining method based on a spatial index, comprising the following steps:
step 1: integrating geographic location information in a geographic social network, and assigning a location label to each node as a basis for building a tree-like spatial index and mining frequent patterns in subsequent steps;
step 2: constructing an NaR-Tree index structure according to geographic location attributes of nodes and a coverage relationship between areas, wherein the spatial index transforms an area retrieval problem into a tree search problem, that is, nodes representing a target area are searched for from a root node;
step 3: setting a target search area, a result set size k and an example pattern c, and returning k patterns with the highest frequency expanded from c in the target area; and
step 4: returning a result set comprising k patterns.

2. The frequent pattern mining method based on a spatial index according to claim 1, wherein step 2 comprises:
specifying that each node of a geographic social network graph G (V, E, L) contains geographic location information of a current node; and
constructing a data file by r rectangles, wherein each node of NaR-Tree accommodates n rectangles.

3. The frequent pattern mining method based on a spatial index according to claim 2, wherein constructing the data file comprises:
step 2.1: preprocessing the data file;
step 2.2: constructing leaf nodes;
step 2.3: merging nodes at the same layer; and
step 2.4: generating the root node.

4. The frequent pattern mining method based on a spatial index according to claim 3, wherein step 2.1 comprises preprocessing the data file, so that r nodes in the file are in [r/n] continuous rectangular groups respectively, and arranging these rectangular groups in order according to geographic locations, wherein all nodes comprised in the network graph, and all edge types and a number of edge types are recorded in the rectangles.

5. The frequent pattern mining method based on a spatial index according to claim 3, wherein step 2.2 comprises converting each rectangle group generated in step 2.1 into a leaf node, wherein each leaf node comprises at most n rectangles.

6. The frequent pattern mining method based on a spatial index according to claim 3, wherein step 2.3 comprises merging tree nodes with a small distance at the same layer, with a minimum bounding rectangle corresponding to the tree nodes as one of rectangles in tree nodes at an upper layer, wherein graph information contained in the nodes is merged while the tree nodes are merged.

7. The frequent pattern mining method based on a spatial index according to claim 3, wherein step 2.4 comprises iterating operations of step 2.3 from a layer where the leaf nodes are located until the root node is generated, that is, until all rectangles are covered.

8. The frequent pattern mining method based on a spatial index according to claim 1, wherein step 3 comprises:
step 3.1: accessing NaR-Tree to determine a node where a target search area is located, wherein a process of searching for the node where the target area is located from NaR-Tree is a process similar to tree search, wherein step 3.1 comprises:
step 3.1.1: checking whether a current node covers the target search area; and
step 3.1.2: if yes, accessing child nodes of the current node and performing step 3.1.1, and if not, returning to the current node and performing operations of steps 3.1.1 and 3.1.2 from the root node until a return result, that is, the minimum bounding rectangle containing the target search area, is obtained;
step 3.2: retrieving and generating, in G, a subgraph corresponding to the target area according to subgraph information stored in the tree node after the NaR-Tree node corresponding to the target search area is obtained, wherein step 3.2 comprises:
step 3.2.1: obtaining all graph nodes (v1, v2, . . . , vn) stored in the NaR-Tree node; and
step 3.2.2: retrieving interconnected edges between the above nodes from G and constructing a corresponding subgraph S according to node and edge information obtained in steps 3.2.1 and 3.2.2;
step 3.3: initializing two priority queues required for a mining pattern, wherein step 3.3 comprises:
step 3.3.1: generating a maximum priority queue q1 and a minimum priority queue q2, wherein a ranking standard of the priority queues is a support degree of the pattern in the queue, and a size of q2 is set to k; and
step 3.3.2: calculating a support degree of an initial pattern c, and placing c into q1;
step 3.4: dequeuing a head element p1 of q1, and comparing with a head element p2 of q2 in support degree;
step 3.5: performing the following steps when the support degree of p1 is greater than that of p2:
step 3.5.1: performing an inert retrieval operation according to node and edge information of p1 to accelerate support degree calculation; and
step 3.5.2: calculating a true support degree of p1; if the true support degree is still greater than that of p2, dequeuing p2 and expanding p1, and finally enqueuing p1; and
repeating steps 3.4 and 3.5 until the queue q1 is null, wherein at this time, k elements in q2 are required k frequent patterns.

9. The frequent pattern mining method based on a spatial index according to claim 8, wherein step 3.3.2 comprises calculating the support degree of the pattern c according to edge information of an example of c in the subgraph S.

10. The frequent pattern mining method based on a spatial index according to claim 9, wherein step 3.3.2 comprises:
obtaining all examples {I1, I2, . . . , Im} of c in the subgraph S;
obtaining all edge information of all the examples to generate an edge set; and
counting and returning a number of unique edges in the edge set;
wherein a value returned by step a3 is the support degree of the pattern c; and
wherein the mining officially starts after the initialization step is completed.

11. The frequent pattern mining method based on a spatial index according to claim 8, wherein the inert retrieval operation step of step 3.5.1 comprises:
skipping performing re-retrieval if node and edge types of p1 are comprised in S; and
otherwise, retrieving S again.

12. The frequent pattern mining method based on a spatial index according to claim 8, wherein the step of expanding p1 of step 3.5.2 comprises:
generating all possible sub-patterns of p1 according to stored edge information in the NaR-Tree node;
temporarily setting the support degree of the sub-patterns as a real support degree of p1; and
adding all the generated sub-patterns to q1.
